(19) United States
(12) Patent Application Publication
(10) Pub. No.: US 2014/0201074 A1
(43) Pub. Date: Jul. 17, 2014

(54) SPLITTING USAGE CHARGES BASED ON PREFERENCES

(71) Applicant: VERIZON PATENT AND LICENSING INC., Basking Ridge, NJ (US)

(72) Inventors: James NI, Westford, MA (US); Elliot G. EICHEN, Arlington, MA (US)

(73) Assignee: VERIZON PATENT AND LICENSING INC., Basking Ridge, NJ (US)

(21) Appl. No.: 13/742,825

(22) Filed: Jan. 16, 2013

(51) Int. Cl. G06Q 20/10

(52) U.S. Cl. CPC G06Q 20/102
USPC 705/40

(57) ABSTRACT

One or more servers may determine delivery charge information for delivery of a content file to a user device; receive a first set and a second of preferences identifying whether the delivery of the content file can be charged to an account of the user device or to an account of the one or more servers; generate a delivery instruction based on the first set of preferences, the second set of preferences, and the delivery charge information, the delivery instruction identifying a first charge value and a second charge value; receive a request for the content file from the user device; and cause a billing settlement function to be performed to assess the first charge value to the account of the user device or to assess the second charge value to the account of the one or more servers based on delivering the content file to the user device.

### BACKGROUND

User devices sometimes connect with a network via a network provider to receive content (e.g., web text content, video content, audio content, or some other content). Network providers sometimes charge a user account, associated with the user device, based on usage of the network (e.g., an amount of data transferred to and/or from the user device).

### BRIEF DESCRIPTION OF THE DRAWINGS

FIGS. 1A-1B illustrate an example overview of an implementation described herein;

FIG. 2 illustrates an example environment in which systems and/or methods, described herein, may be implemented;

FIG. 3 illustrates example components of a device that may be used within the environment of FIG. 2;

FIGS. 4A-4B illustrate an example data structure that may be stored by one or more devices in the environment of FIG. 2;

FIG. 5 illustrates a flowchart of an example process for generating delivery instructions for a particular content file, and providing the particular content file for delivery to a user device;

FIG. 6 illustrates a flowchart of an example process for splitting delivery charges for the delivery of a content file between multiple parties; and

FIGS. 7-10 illustrate example implementations as described herein.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may permit a network provider to split network usage charges among different parties (e.g. a content provider and a content recipient, such as a user of a user device). In some implementations, network usage may refer to the delivery of a content file from a content provider to a user device via a network.

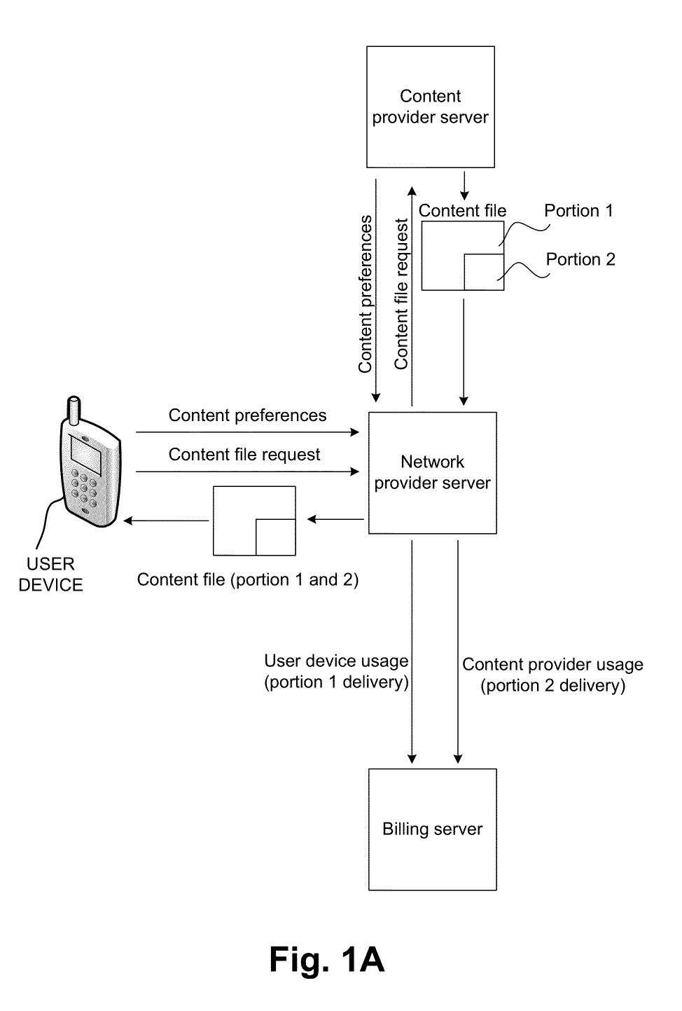

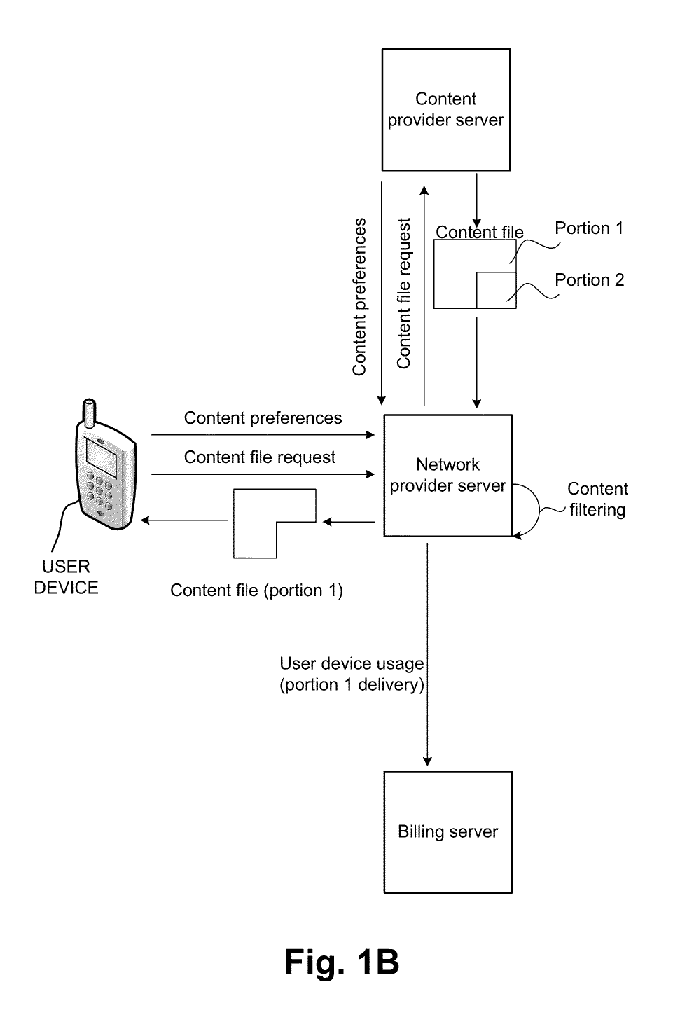

FIGS. 1A-1B illustrate an example overview, as described herein. As shown in FIG. 1A, a user device may communicate with a content provider server, via a network provider server, to request a particular content file from the content provider server. The user device may also provide the network provider server with information regarding user device content preferences (e.g., content files that the user of the user device may or may not wish to pay for delivery to the user device). In some implementations, the content provider server may provide, to the network provider server, information regarding content provider content preferences (e.g., content files whose delivery may or may not be charged to an account of the content provider server).

In FIG. 1A, assume that the content file includes two portions (e.g., a first portion and a second portion). Further, assume that the user device content preferences include information to prevent an account of the user device from being charged for delivery of the second portion. For example, the second portion may contain an advertisement, or some other content that the user of the user device may not wish to pay for delivery to the user device. Further, assume that the content provider content preferences include information to authorize charging an account of the content provider for delivery of the second portion to the user device.

Given these assumptions, a network provider server may provide, to the user device and on behalf of the content provider server, the first and second portions of the content file. For example, the network provider may receive a request for the content file and provide the request for the content file to the content provider server. In some implementations, the network provider server may attach the user device content preferences to the content file request when providing the content file request to the content provider server (e.g., to allow the content provider server to tag the content file to identify portions of the content file whose delivery may be charged to different accounts (e.g., an account of the user device and/or an account of the content provider server).

In some implementations, the network provider server may provide, to a billing server, information to identify charges to assess to respective accounts of the user device and the content provider (e.g., based on network usage by the user device and by the content provider server). For example, the billing server may assess a charge, to the account of the user device, corresponding to the delivery of the first portion of the content file, and may assess a charge, to the account of the content provider server, corresponding to the delivery of the second portion of the content file. As a result, delivery charges and/or network usage charges for delivery of content may be split among multiple parties. In some implementations, the charge may be assessed in the form of a currency unit, and/or may be assessed in the form of a network usage unit (e.g., a kilobyte, a megabyte, etc.).

Referring now to FIG. 1B, assume that the user content preferences include information to prevent the account of the user device from being charged for delivery of the second portion. Further assume that the content provider content preferences include information that indicates that the account of the content provider is not authorized to be charged for delivery of the second portion of the content. Given these assumptions, the network provider server may filter out the second portion of the content and prevent the second portion of the content file from being delivered to the user device. As a result, the user device may not receive the second portion of the content file and neither the account of the user device nor the account of the content provider may be charged when the user of the user device and the operator of the content provider server or the user device do not authorize charges for delivery of the second portion of the content. Thus, the user of the user device may control content delivery and may control associated charges for the delivery of content.

While the systems and/or methods may be described as splitting delivery costs for the delivery of a content file from a content provider server to a user device, in practice, the systems and/or methods may split delivery costs for the delivery of multiple portions of the content file. Additionally, or alternatively, the systems and/or methods may split delivery costs for the delivery of multiple different content files. For example, a first portion of a particular content file may be charged to an account of a user device while a second portion of the particular content file may be charged to an account of a content provider server. Additionally, or alternatively, a first content file may be charged to the account of the user device while a second content file may be charged to the account of content provider server.

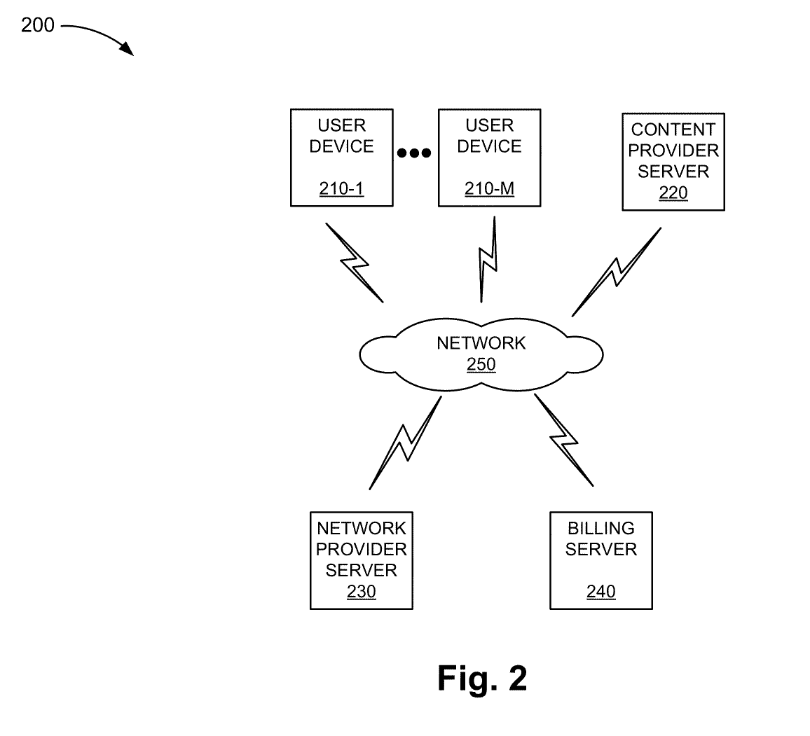

FIG. 2 is a diagram of an example environment 200 in which systems and/or methods described herein may be implemented. As shown in FIG. 2, environment 200 may include user devices 210-1, . . . , 210-M (where M≧1), content provider server 220, network provider server 230, and billing server 240.

User device 210 may include any device capable of communicating via a network, such as network 250. For example, user device 210 may correspond to a mobile communication device (e.g., a smart phone or a personal digital assistant (PDA)), a portable computer device (e.g., a laptop or a tablet computer), etc. In some implementations, user device 210 may correspond to a client device, such as a desktop computer, and may be used to provide delivery preference information to network provider server 230 via a user interface associated with network provider server 230 (e.g., a web portal or some other user interface). For example, a particular user device 210 may communicate with network provider server 230 to provide the delivery preference information via a set of login credentials (e.g., a username and a password) that uniquely identifies the particular user device 210.

Content provider server 220 may include one or more computing devices, such as a server device or a collection of server devices. In some implementations, content provider server 220 may store a content file (e.g., a video file, an audio file, a web page, a text file, an image file, etc.) for delivery to user device 210. In some implementations, content provider server 220 may communicate with network provider server 230 to identify delivery billing rates for a content file for delivery from content provider server 220 to user device 210. In some implementations, content provider server 220 may provision a content file to identify a responsible account to charge for delivery of the content file (e.g., an account of user device 210 and/or an account of content provider server 220).

Network provider server 230 may include a computing device, such as a server device, or a collection of server devices. In some implementations, network provider server 230 may include a user preference management portion, a content provider preference management portion, a preference enabling portion, and a usage enforcement and accounting portion. In some implementations, network provider server 230 may receive user device preference information from user device 210 (e.g., via the user preference management portion). Additionally, or alternatively, network provider server 230 may receive content provider preference information from content provider server 220 (e.g., via the content provider preference management portion). Additionally, or alternatively, network provider server 230 may attach user device preference information to a request for a content file when user device 210 requests the content file from content provider server 220 (e.g., via the preference enabling portion).

Additionally, or alternatively, network provider server 230 may apply a content delivery instruction to a particular content file (e.g., via the usage enforcement and account portion) based on user device preference information, content provider preference information, and/or information associated with the particular content file. In some implementations, the content delivery instruction may be based on a tag associated with the particular content file and may identify responsible accounts to charge for delivery of the particular content file. In some implementations, network provider server may count data usage corresponding to a responsible account to charge for delivery of the particular content file.

In some implementations, network provider server 230 may deliver a particular content file to user device 210 based on the user device preference information, the content provider preference information, and/or the content delivery instruction. For example, network provider server 230 may provide the content file to user device 210, and may provide, to billing server 240, information identifying responsible accounts to charge for delivery of the content file.

Billing server 240 may include one or more computing devices, such as a server device or a collection of server devices. In some implementations, billing server 240 may receive delivery information, from network provider server 230, that identifies responsible accounts to charge for delivery of a content file, or a portion of the content file. In some implementations, billing server 240 may perform a billing settlement function to assess debit and/or credit transactions to accounts associated with user device 210, content provider server 220, and/or network provider server 230. As described above, billing server 240 may assess a charge in the form of a currency unit and/or a network usage unit.

Network 250 may include one or more wired and/or wireless networks. For example, network 250 may include a cellular network, a public land mobile network (PLMN), a second generation (2G) network, a third generation (3G) network, a fourth generation (4G) network, a fifth generation (5G) network, and/or another network. Additionally, or alternatively, network 250 may include a local area network (LAN), a wide area network (WAN), a wireless fidelity (WiFi) network, a metropolitan network (MAN), a telephone network (e.g., the Public Switched Telephone Network (PSTN)), an ad hoc network, a managed IP network, a virtual private network (VPN), an intranet, the Internet, a fiber optic-based network, and/or combination of these or other types of networks.

The quantity of devices and/or networks, illustrated in FIG. 2, is not limited to what is shown. In practice, there may be additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

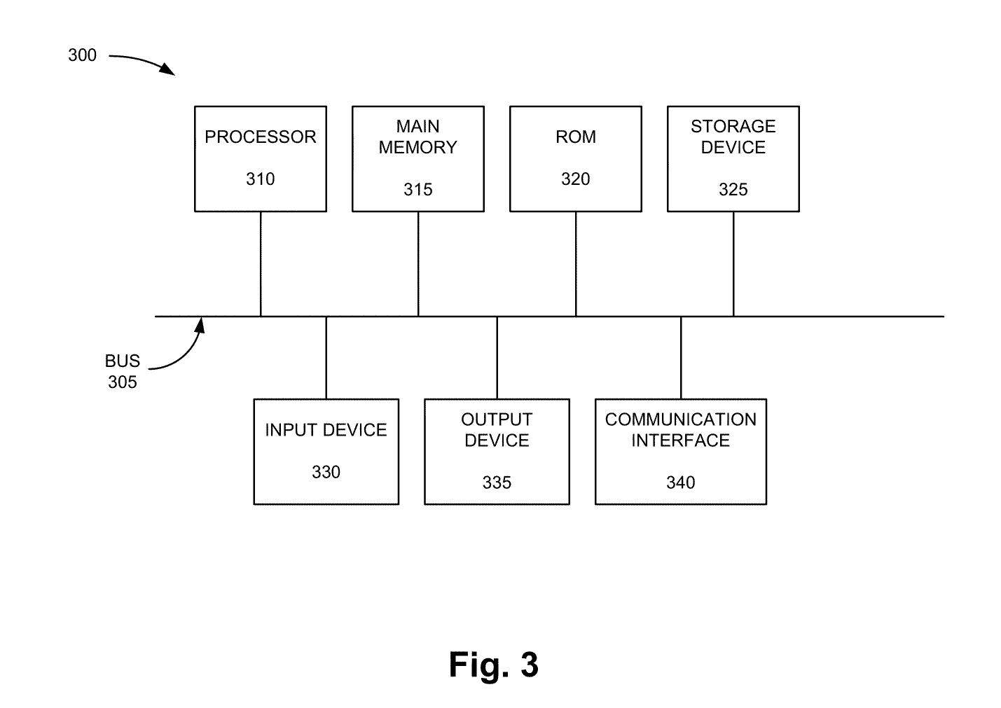

FIG. 3 illustrates example components of a device 300 that may be used within environment 200 of FIG. 2. Device 300 may correspond to user device 210, content provider server 220, network provider server 230, or billing server 240. Each of user device 210, content provider server 220, network provider server 230, or billing server 240 may include one or more devices 300 and/or one or more components of device 300.

As shown in FIG. 3, device 300 may include a bus 305, a processor 310, a main memory 315, a read only memory (ROM) 320, a storage device 325, an input device 330, an output device 335, and a communication interface 340. In some implementations, device 300 may include additional components, fewer components, different components, or differently arranged components.

Bus 305 may include a path that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a component that permits an operator to input information to device 300, such as a control button, a keyboard, a keypad, or another type of input device. Output device 335 may include a component that outputs information to the operator, such as a light emitting diode (LED), a display, or another type of output device. Communication interface 340 may include any transceiver-like mechanism that enables device 300 to communicate with other devices or networks. In one implementation, communication interface 340 may include a wireless interface, a wired interface, or a combination of a wireless interface and a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include memory space within a single physical storage device or memory space spread across multiple physical storage devices.

The software instructions may be read into main memory 315 from another computer-readable medium, such as storage device 325, or from another device via communication interface 340. The software instructions contained in main memory 315 may direct processor 310 to perform processes that will be described later. Alternatively, hardwired circuitry may be used in place of or in combination with software instructions to implement processes described herein. Thus, implementations described herein are not limited to any specific combination of hardware circuitry and software.

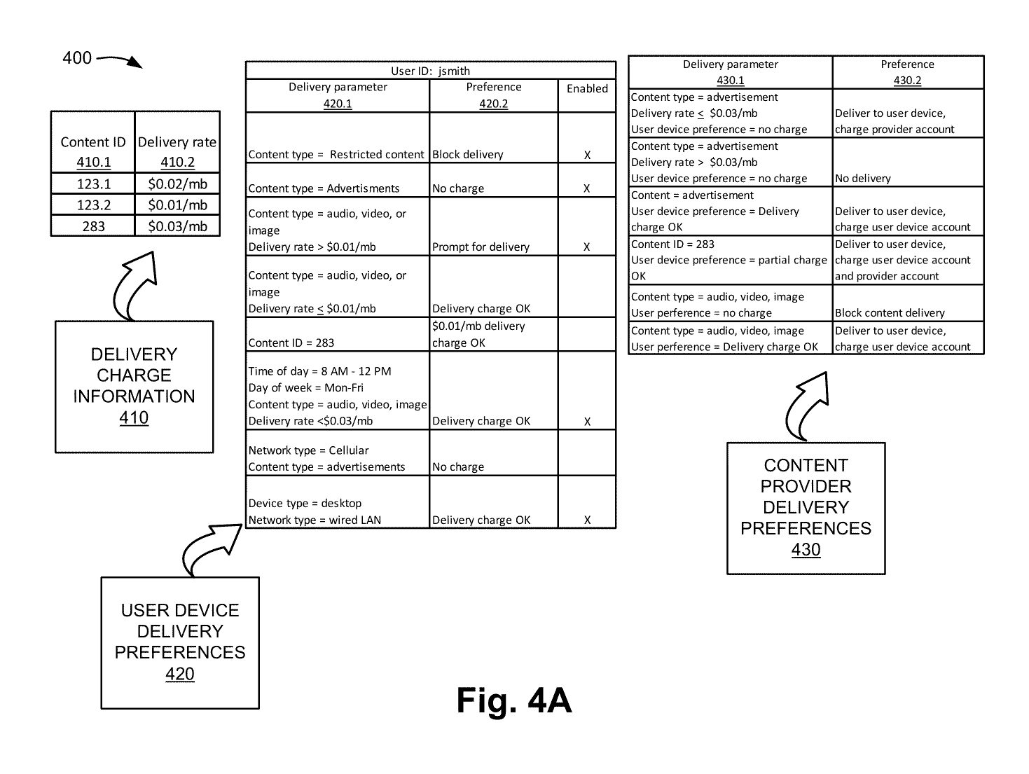

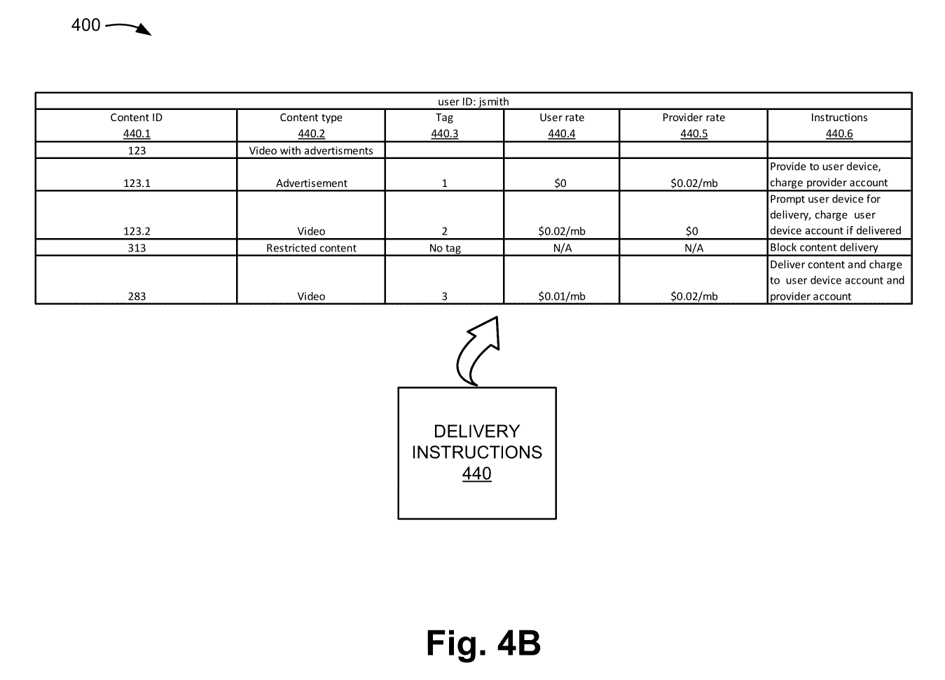

FIGS. 4A-4B illustrate an example data structure 400 that may be stored by one or more devices in environment 200, such as content provider server 220, network provider server 230, or billing server 240. In one implementation, data structure 200 may be stored in a memory of content provider server 220, network provider server 230, or billing server 240. In another implementation, data structure 400 may be stored in a memory separate from, but accessible by, content provider server 220, network provider server 230, or billing server 240. In some implementations, a portion of data structure 400 may be stored by one device in environment 200, and another portion of data structure 400 may be stored by another device in environment 200.

In some implementations, a particular instance of data structure 400 may store information identifying a particular set of delivery preferences and a particular set of delivery instructions for a particular user device 210. Another instance of data structure 400 may store another set of delivery preferences and another set of delivery instructions for another user device 210.

As shown in FIGS. 4A-4B, data structure 400 may include delivery charge information field 410, user device delivery preferences field 420, content provider delivery preferences field 430, and delivery instructions field 440.

Delivery charge information field 410 may store information to identify a delivery rate (e.g., a charge value per unit of data) for delivering a particular content file from content provider server 220 to user device 210. For example, content provider server 220 may provide, to network provider server 230, information for a content file (e.g., an address, such as a universal resource locator (URL) or a uniform resource identifier (URI)) and may receive, from network provider server 230, a delivery rate for delivery of the content file from content provider server 220 to user device 210. In some implementations, network provider server 230 may determine the delivery rate for a content file based on a network resource demand associated with delivering the content file. For example, network provider server 230 may access a portion of the content file (e.g., via the address) and measure the network resource demand based on a resolution of the content file, a bitrate of the content file, a size of the content file, and/or some other information associated with the content file.

As shown in FIG. 4A, delivery charge information field 410 may include content identifier (ID) field 410.1 and delivery rate field 410.2. Content ID field 410.1 may store information to uniquely identify a content file. For example, content ID field 410.1 may store a string of characters or some other identifier. In some implementations, content ID field 410.1 may store additional information not shown in FIG. 4A (e.g., a description, a type, or some other narrative associated with the content file).

Delivery rate field 410.2 may store information to identify the delivery of a content file from content provider server 220 to user device 210 (e.g., based on delivery rate information received from network provider server 230, as described above). In some implementations, delivery rate field 410.2 may store information identifying a charge value per unit of data (e.g., $0.02/megabyte (mb) or $0.01/minute).

User device delivery preferences field 420 may store information to identify content files whose delivery may be charged to an account associated with user device 210. In some implementations, user device delivery preferences field 420 may store an identifier associated with a user of a particular user device 210 associated with a particular instance of user device delivery preferences field 420. As an example, assume that the user device delivery preferences field 420 shown in FIG. 4A is associated with a user having the user ID “jsmith.” Thus, user device delivery preferences field 420 may store the user ID “jsmith.” Information stored by user device delivery preferences field 420 may be received by network provider server 230 via a user interface (e.g., a web portal or some other user interface) of network provider server 230. In some implementations, network provider server 230 may provide information stored by user device delivery preferences field 420 to content provider server 220. For example, as described above, network provider server 230 may attach information regarding user device preferences to a request for a particular content file.

As shown in FIG. 4A, user device delivery preferences field 420 may include delivery parameter field 420.1 and preference field 420.2. Delivery parameter field 420.1 may store a parameter that may be used to identify a particular content file, and preference field 420.2 may store information to identify delivery instructions for the particular content file and/or whether the account, associated with user device 210, may be charged for delivery of the particular content file. Additionally, or alternatively, delivery parameter field 420.1 may store some other parameter to identify a corresponding preference. For example, delivery parameter field 420.1 may store parameters such as a type of content file, an identifier of the content file, a type of network via which the content file is requested, a type of device via which the content file is requested, a time of day or day of week in which the content file is requested, a current geographic location of user device 210, or some other parameter to identify a corresponding preference. In some implementations, delivery parameter field 420.1 may store multiple parameters to identify a corresponding preference.

As an example, assume that a user of user device 210 selects to prevent the account, associated with user device 210, from being charged for the delivery of content files of the “advertisements” content file type. Given this assumption, delivery parameter field 420.1 may store the information “content type=advertisements” and preference field 420.2 may store the information “no charge.” In this case, user device 210 may receive an advertisement when content provider server 220 allows an account of content provider server 220 to be charged for delivery of the content file.

As an another example, the user of user device 210 may allow the account of user device 210 to be charged for the delivery of audio, video, or image content file types and when the delivery rate for the delivery of the content file is ≦$0.01/mb. In this case, delivery parameter field 420.1 may store information such as “content type=audio, video, or image, delivery rate ≦$0.01/mb” and preference field 420.2 may store information such as “delivery charge OK” to identify that the account of user device 210 may be charged for the delivery of audio, video, or image content file types and when the delivery rate for the delivery of the content file is ≦$0.01/mb.

As another example, the user of user device 210 may select to be prompted for permission to charge the account of user device 210 for the delivery of audio, video, or image content file types and when the delivery rate for the delivery of the content file is >$0.01/mb. In this case, delivery parameter field 420.1 may store information such as “content type=audio, video, or image, delivery rate >$0.01/mb” and preference field 420.2 may store information such as “prompt for delivery” to identify that user device 210 may be prompted for permission to charge the account of user device 210 for the delivery of audio, video, or image content file types and when the delivery rate for the delivery of the content file is >$0.01/mb.

As another example, the user of user device 210 may allow the account of user device 210 to be charged for the delivery audio, video, or image type content files when the delivery rate is <$0.03/mb and during a particular time of day (e.g., 8 AM-12 PM) and during particular days of the week (e.g., Monday-Friday). In this case, delivery parameter field 420.1 may store information, such as “time of day=8 AM-12 PM, day of week=Mon-Fri, content type=audio, video, image, delivery rate <$0.03/mb and preference field 420.2 may store information such as “delivery charge OK.”

As described above, delivery parameter field 420.1 may store some other information to identify a corresponding preference. For example, as shown in FIG. 4A, delivery parameter field 420.1 may store a parameter, such as a network type (e.g., a cellular network type, a wired LAN network type, or some other type) or a device type (e.g., a desktop device, a mobile device, etc.). As a result, the user of user device 210 may specify a variety of preferences for different conditions or parameters. As further shown in FIG. 4A, user device delivery preferences field 420 may include information to identify particular preferences that are enabled or disabled. For example, the user of user device 210 may select to enable or disable a particular preference at any time.

In some implementations, information stored by user device delivery preferences field 420 may correspond to a black list of content files that the user of user device 210 does not wish to receive. For example, information stored by user device delivery preferences field 420 may correspond to a parental control, or some other type of black list. In an example shown in FIG. 4A, delivery parameter field 420.1 may store the information “content type=restricted content” and preference field 420.2 may store the information “block delivery.”

While particular examples of parameters and associated preferences are shown in user device delivery preferences field 420, in practice, the number, combinations, and hierarchy of parameters and preferences may vary from what is shown.

Content provider delivery preferences field 430 may store information to identify content files whose delivery may be charged to an account associated with content provider server 220. Information stored by content provider delivery preferences field 430 may be received by network provider server 230 via a user interface (e.g., a web portal or some other user interface) of network provider server 230.

As shown in FIG. 4A, content provider delivery preferences field 430 may include delivery parameter field 430.1 and preference field 430.2. Delivery parameter field 430.1 may store a parameter that may be used to identify a particular content file, and preference field 430.2 may store information to identify delivery instructions of the particular content file and/or whether the account, associated with content provider server 220, may be charged for delivery of the particular content file. As an example, assume that an operator of content provider server 220 selects to allow the account of content provider server 220 to be charged for delivery of an advertisement type content when the delivery rate is ≦$0.03/mb and when a user device preference indicates that user device 210 does not allow for the account of user device 210 to be charged for delivery (e.g., based on information stored by preference field 420.2). In this case, delivery parameter field 430.1 may store the information “content type=advertisement, delivery rate ≦$0.03/mb, user device preference=no charge” and preference field 430.2 may store the information “deliver to user device, charge provider account” to indicate that the account of content provider server 220 may be charged for delivery of content files matching the parameters stored by delivery parameter field 430.1.

While particular examples of parameters and associated preferences are shown in content provider delivery preferences field 430, in practice, the number, combinations, and hierarchy of parameters and preferences may vary from what is shown. For example, content provider delivery preferences field 430 may store some other parameter or some other content type other than what is shown in FIG. 4A (e.g., a text advertisement content type, an image advertisement content type, a web page content type, a content class, or some other information).

Delivery instructions field 440 may store a set of delivery instructions for a particular content file, or a particular portion of a content file. In some implementations, information stored by delivery instructions field 440 may be based on information stored by delivery charge information field 410, user device delivery preferences field 420, and/or content provider delivery preferences field 430. For example, content provider server 220 may combine information stored by delivery charge information field 410, user device delivery preferences field 420, and/or content provider delivery preferences field 430 to generate delivery instructions stored by delivery instructions field 440. In some implementations, delivery instructions field 440 may include content ID field 440.1, content type field 440.2, tag field 440.3, user rate field 440.4, provider rate field 440.5, and instructions field 440.6.

Content ID field 440.1 may store information that identifies a particular content file stored by content provider server 220 having a corresponding set of delivery instructions. Content ID field 440.1 may store information in any format having any number of characters. In some implementations, content ID field 440.1 may store information to identify a portion of a content file having a corresponding set of delivery instructions. For example, the content file having the content ID “123” may include two portions, such as the content file having the content ID “123.1” and “123.2.” In some implementations, each of the content files having the content file IDs of “123.1” and “123.2” may have a corresponding set of delivery instructions.

Content type field 440.2 may store information to identify a type associated with a particular content file. For example, Content ID field 440.1 may store a type, such as “video,” “advertisement,” or some other type.

Tag field 440.3 may store a tag identifier to identify a set of delivery instructions associated with a particular content file. For example, as described above, content provider server 220 may tag the particular content file when the particular content file is requested by user device 210. In some implementations, network provider server 230 may identify a corresponding set of delivery instructions based on identifying the tag attached to the particular content file. In some implementations, a tag may indicate a content file whose delivery may be charged to an account of content provider server 220. For example, content provider server 220 may tag a content file to notify network provider server 230 to charge the account of content provider server 220 for delivery of the content file. In some implementations, a content file may not have a tag (e.g., when content provider server 220 does not tag the content file). In a situation where the content file does not have a tag, network provider server 230 may provide the content file to user device 210 and charge the account of user device 210 for delivery of the content file. Alternatively, network provider server 230 may identify that the content file is not authorized to be charged to the account of user device 210 (e.g., based on information stored by user device delivery preferences field 420), and may filter out the content file (e.g., prevent delivery of the content file). In some implementations, a tag may indicate accounts (e.g., the account of user device 210 and/or the account of content provider server 220) that may be charged for the delivery of the content file.

User rate field 440.4 may store information identifying a delivery charge rate used to calculate a value to assess to an account associated with user device 210. In some implementations, information stored by user rate field 440.4 may be based on information stored by delivery charge information field 410, user device delivery preferences field 420, and/or content provider delivery preferences field 430. For example, assume that user device delivery preferences field 420 indicates that an account of user device 210 may not be charged for the delivery of advertisement type content files (e.g., when delivery parameter field 420.1 stores “content type=advertisements” and preference field 420.2 stores “no charge”). Given this assumption, user rate field 440.4 may store a delivery charge value of $0. As another example, assume that user device delivery preferences field 420 indicates that an account of user device 210 may be charged for the delivery of video type content files (e.g., when delivery parameter field 420.1 stores “content type=videos” and preference field 420.2 stores “delivery charge OK”). Further assume that delivery charge information field 410 identifies a delivery rate of $0.02/megabyte (mb) to deliver the content file. Given these assumptions, user rate field 440.4 may store a delivery charge rate of $0.02/mb. In some implementations, user rate 440.4 may store a variable rate (e.g., an on-demand rate) such that content provider server 220 may identify different rates to charge to an account of user device 210 (e.g., based on a subscriber level of user device 210, a device type, a network type, or some other factor).

Provider rate field 440.5 may store information identifying a delivery charge rate used to calculate a value to assess to an account associated with content provider server 220. In some implementations, information stored by provider rate field 440.5 may be based on information stored by delivery charge information field 410, user device delivery preferences field 420, and/or content provider delivery preferences field 430. For example, assume that user device delivery preferences field 420 indicates that an account of user device 210 may not be charged for the delivery of advertisement type content files (e.g., when delivery parameter field 420.1 stores “content type=advertisements” and preference field 420.2 stores “no charge”). Further, assume that content provider delivery preferences field 430 indicates that an account of content provider server 220 may be charged for the delivery of the advertisement type content files when user device delivery preferences field 420 indicates that the account of user device 210 may not be charged for the delivery of advertisement type content files (e.g., delivery parameter field 430.1 stores information, such as “content type=advertisement; user device preference=no charge” and preference field 430.2 stores information, such as “deliver to user device, charge provider account”). Further assume that delivery charge information field 410 stores a delivery charge rate of $0.02/mb for the delivery a particular advertisement type content file. Given these assumptions, provider rate field 440.5 may store a delivery charge rate of $0.02/mb corresponding to a delivery charge rate to deliver the particular advertisement type content file.

Instructions field 440.6 may store information to identify instructions associated with the delivery of particular content files. In some implementations, network provider server 230 may deliver content from content provider server 220 to user device 210 in accordance with information stored by instructions field 440.6. In some implementations, information stored by instructions field 440.6 may be based on information stored by delivery charge information field 410, user device delivery preferences field 420, and/or content provider delivery preferences field 430. For example, assume that user device delivery preferences field 420 stores information to direct network provider server 230 to prompt user device 210 for delivery of a content file when the delivery rate of the content file is >$0.01/mb. Further, assume that delivery charge information field 410 stores a delivery rate of $0.02/mb for a particular content file. Given these assumptions, instructions field 440.6 may store information, such as “prompt user device for delivery, charge user device account if delivered.”

As shown in FIG. 4B, instructions field 440.6 may store some other instruction corresponding to information stored by delivery charge information field 410, user device delivery preferences field 420, and/or content provider delivery preferences field 430. In some implementations, instructions field 440.6 may store some other instruction not shown in FIG. 4B. For example, instructions field 440.6 may store an instruction to direct network provider server 230 to compress a particular content file when the content file is requested by a particular type of user device 210. For example, instructions field 440.6 may store an instruction to compress a video type content file when a mobile or portable user device 210 requests the content file.

While particular fields are shown in a particular format in data structure 400, in practice, data structure 400 may include additional fields, fewer fields, different fields, or differently arranged fields than are shown in FIGS. 4A-4B.

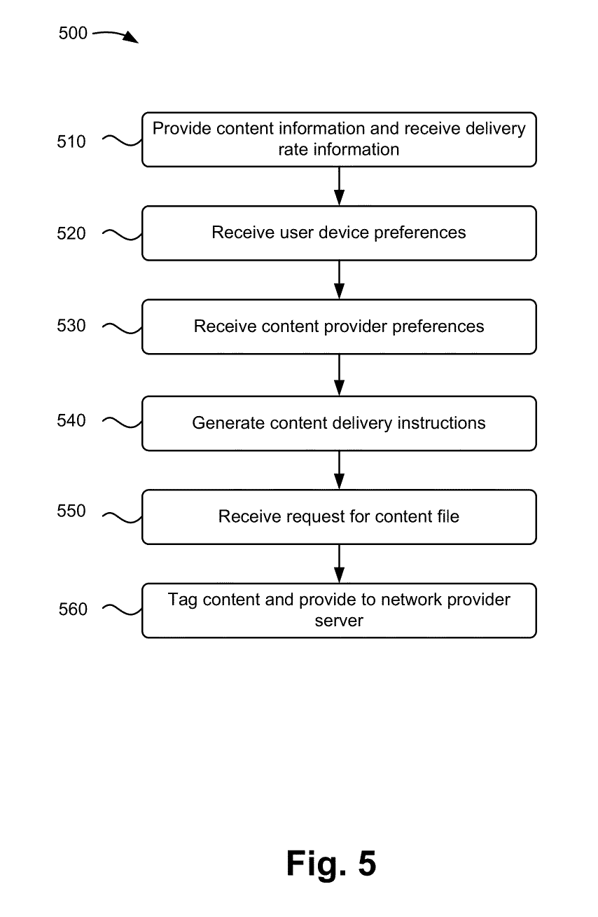

FIG. 5 illustrates a flowchart of an example process 500 for generating delivery instructions for a particular content file, and providing the particular content file for delivery to user device 210. In one implementation, process 500 may be performed by one or more components of content provider server 220. In another implementation, some or all of blocks of process 500 may be performed by one or more components of another device in environment 200 (e.g., network provider server 230 and/or billing server 240), or a group of devices including or excluding content provider server 220.

As shown in FIG. 5, process 500 may include providing content information and receiving delivery rate information (block 510). For example, content provider server 220 may provide information for a content file stored by content provider server 220 (e.g., an address, a content file ID, a description associated with the content file, the size of the content file, the bitrate of the content file, the resolution of the content file, etc.) to network provider server 230. In some implementations, content provider server 220 may receive delivery rate information from network provider server 230. For example, as described above, network provider server 230 may determine delivery rate information by accessing a portion of the content file (e.g., via the address) and measuring the network resource demand based on a resolution of the content file, a bitrate of the content file, a size of the content file, a geographic location associated with the content file, and/or some other information associated with the content file. Additionally, or alternatively, network provider server 230 may determine the delivery rate information using some other technique. In some implementations, content provider server 220 may store the delivery rate information in delivery charge information field 410 of data structure 400. In some implementations, the delivery rate information may correspond to a service agreement between content provider server 220 and network provider server 230.

Process 500 may also include receiving user device preferences (block 520). For example, content provider server 220 may receive user device preferences for a particular user device 210 from network provider server 230 (e.g., when user device 210 provides network provider server 230 with the user device preferences via a user interface of network provider server 230). In some implementations, content provider server 220 may receive user device preferences directly from user device 210 without involving network provider server 230 (e.g., via a user interface of content provider server 220, such as a web portal or some other user interface). In some implementations, content provider server 220 may store the user device preferences in user device delivery preferences field 420 of data structure 400.

Process 500 may further include receiving content provider preferences (block 530). For example, content provider server 220 may receive the content provider preferences via a user interface of content provider server 220. As described above, the content provider preferences may relate to content files (or portions of content files) that an account of content provider server 220 may be charged for delivery from content provider server 220 to user device 210. In some implementations, content provider server 220 may store the content provider preferences in content provider delivery preferences field 430 of data structure 400.

Process 500 may also include generating content delivery instructions (block 540). For example, content provider server 220 may generate the content delivery instructions based on information stored by delivery charge information field 410, user device delivery preferences field 420, and/or content provider delivery preferences field 430. For example, content provider server 220 may generate a content delivery instruction to direct network provider server 230 to provide a particular content file to user device 210 and to charge an account of user device 210 and/or an account of content provider server 220. Some examples of content delivery instructions are described above with respect to instructions field 440.6.

Process 500 may further include receiving a request for a content file (block 550). For example, content provider server 220 may receive a request for the content file from network provider server 230 on behalf of user device 210. In some implementations, the content request may include a content file ID, a URL, and/or some other information associated with identifying the requested content file.

Process 500 may also include tagging the content and providing the content to the network provider server (block 560). For example, content provider server 220 may tag the content file (e.g., by storing the tag in a header of the content file) to identify a delivery instruction associated with the content file and/or to identify an account that may be charged for delivery of the content file. Content provider server 220 may provide the content file to network provider server 230 based on receiving the request for the content file, as described above.

In some implementations, block 560 may be modified from what is described above. For example, content provider server 220 may provide the content file directly to user device 210 without providing the content file to network provider server 230. For example, content provider server 220 may provide the content file directly to user device 210 when receiving a request for the content file from user device 210 or from network provider server 230 (e.g., a request for the content file on behalf of user device 210).

In some implementations, content provider server 220 may forgo tagging the content file. As later described, network provider server 230 may determine delivery instructions for a content file regardless of whether the content file includes a tag. Content provider server 220 may determine whether to tag the content file based on whether network provider server 230 is capable of identifying content file types and/or instructions stored by delivery instructions field 440.

While a particular series of blocks has been described above with regard to FIG. 5, the operations, data flows, and/or the order of the blocks may be modified in other implementations. Further, non-dependent operations and/or data flows may be performed in parallel. For example, block 520 may be performed in conjunction with block 550 (e.g., when network provider server 230 attaches the user device preferences to the request for the content file).

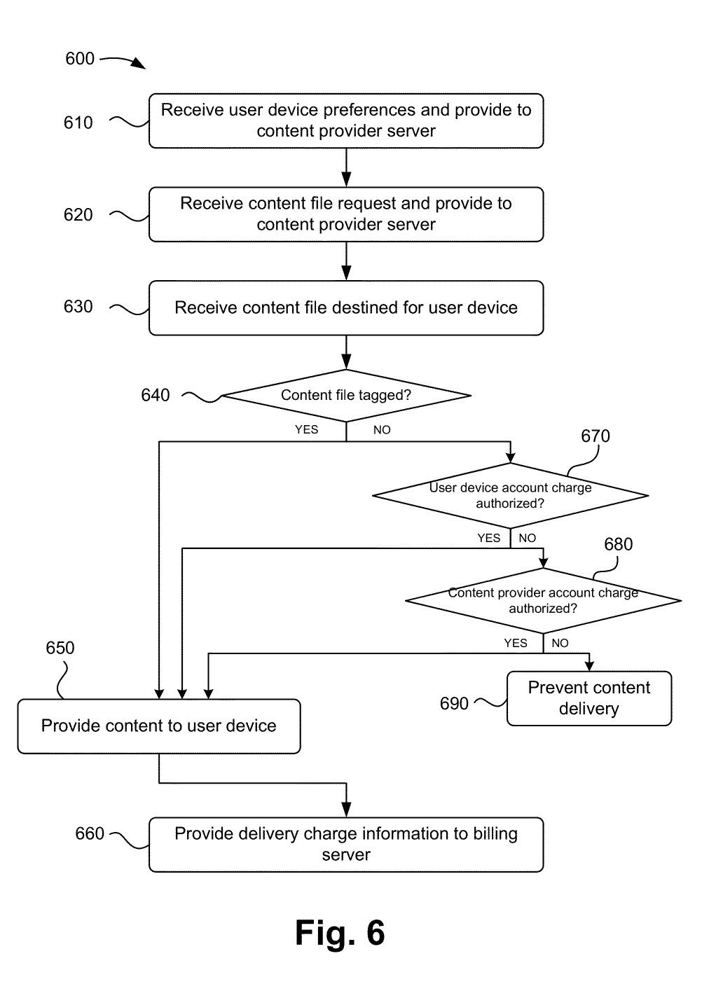

FIG. 6 illustrates a flowchart of an example process 600 for splitting delivery charges for the delivery of a content file between multiple parties. In one implementation, process 600 may be performed by one or more components of network provider server 230. In another implementation, some or all of blocks of process 500 may be performed by one or more components of another device in environment 200 (e.g., content provider server 220 and/or billing server 240), or a group of devices including or excluding network provider server 230.

Process 600 may include receiving user device preferences and providing the user device preferences to a content provider server (block 610). For example, network provider server 230 may receive user device preferences via a user interface of network provider server 230 (e.g., via a web portal or some other user interface). In some implementations, the user device preferences may include a user ID to identify a particular user device 210 associated with the user device preferences. In some implementations, network provider server 230 may provide the user device preferences to content provider server 220. In some implementations, the user device preferences may correspond to information stored by user device delivery preferences field 420.

Process 600 may also include receiving a content file request and providing the content file request to the content provider server (block 620). For example, network provider server 230 may receive the request for the content file from user device 210. As described above, the request for the content file may include an identifier of the content file, a URL of the content file, and/or some other information associated with the content file. In some implementations, network provider server 230 may provide the request for the content file to content provider server 220 to allow network provider server 230 to provide the content file to user device 210 on behalf of content provider server 220.

Process 600 may also include receiving the content file destined for the user device (block 630) and determining whether the content file includes a tag (block 640). For example, network provider server 230 may receive the content file based on requesting the content file, as described above with respect to block 620. In some implementations, network provider server 230 may determine whether the content file includes a tag based on information stored by a header of the content file identifying the tag. Additionally, or alternatively, network provider server 230 may determine whether the content file includes a tag based on some other technique. In some implementations, network provider server 230 may not receive the content file destined for user device 210.

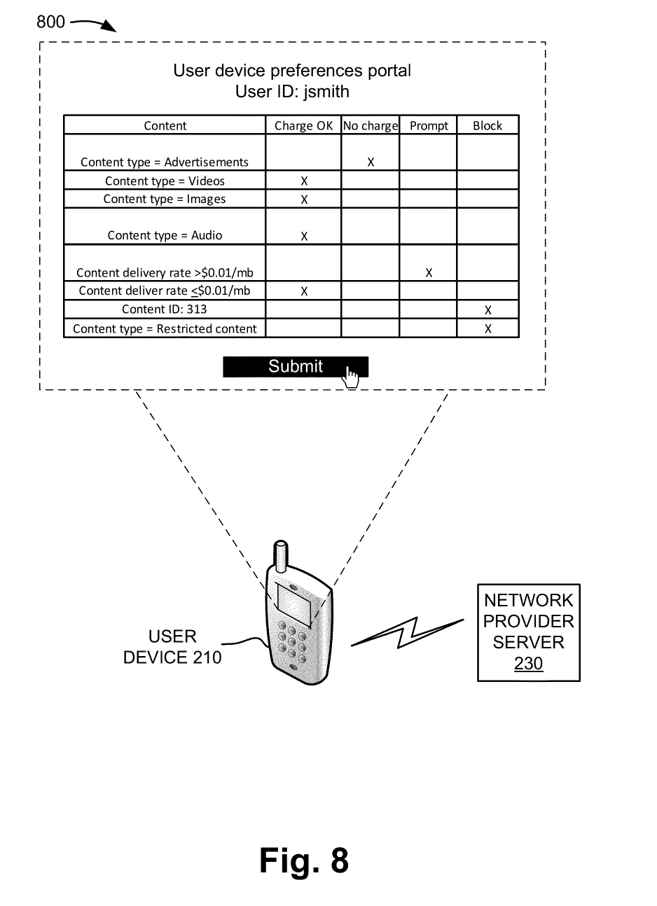

If, for example, the content file includes a tag (block 640-YES), process 600 may further include providing the content to the user device (block 650). For example, network provider server 230 may communicate with content provider server 220 to identify delivery instructions associated with the tag and may deliver the content to user device 210 in accordance with the delivery instructions. For example, as described above, the delivery instructions may direct network provider server 230 to prompt user device 210 for delivery of the content (e.g., when the information stored by instructions field 440.6 directs network provider server 230 to prompt user device 210). For example, network provider server 230 may query user device 210 for an instruction to deliver the content file or an instruction to prevent delivery of the content file. An example of prompting user device 210 is described below with respect to FIG. 8.

As described above, the delivery instructions may include an instruction to compress the content file when user device 210 is a mobile device. For example, network provider server 230 may determine that user device 210 is a mobile device based on receiving a user-agent header provided by user device 210 when user device 210 provides the request for the content file (e.g., as described above in block 620). Additionally, or alternatively, the delivery instructions may include some other instruction not described.

In some implementations, network provider server 230 may deliver the content file to user device 210 on behalf of content provider 230. Alternatively, network provider server 230 may direct content provider 220 to deliver the content file directly to user device 210.

Process 600 may also include providing delivery charge information to a billing server (block 660). For example, network provider server 230 may identify delivery charge information based on the tag included in the content file and/or based on information stored by delivery instructions field 440 and may provide the delivery charge information to billing server 240. In some implementations, network provider server 230 may provide information, to billing server 240, to identify an amount to charge to an account of content provider server 220 and/or to an account of user device 210. Some additional examples of delivery charge information is described above with respect to delivery instructions field 440.

If, on the other hand, the content file does not include a tag (block 640-NO), process 600 may include determining whether the user device account is authorized to be charged for delivery of the content file (block 670). For example, network provider server 230 may determine whether the account of user device 210 may be charged for the content file requested in block 620 based on information stored by user device delivery preferences field 420 and based on information identifying the type of the content file. As an example, assume that user device delivery preferences field 420 stores information to identify that the account of user device 210 may not be charged for the delivery of an advertisement type content file (e.g., delivery parameter field 420.1 stores the information “content type=advertisements” and preference field 420.2 stores the information “no charge”). Further, assume that the requested content file is an advertisement type content file (e.g., based on information stored in a header of the content file to identify the content file as an advertisement type content file). Given these assumptions, network provider server 230 may determine that the account of user device 210 may not be charged for delivery of the content file.

If, for example, the account of user device 210 is not authorized to be charged for the delivery of the content file (block 670-NO), process 600 may further include determining whether the content provider account is authorized to be charged for delivery of the content file (block 680). For example, network provider server 230 may determine whether the account of content provider server 220 may be charged for the content file requested in block 620 based on information stored by content provider delivery preferences field 430 and based on information identifying the type of the content file.

If, for example, the account of content provider server 220 is not authorized to be charged for the delivery of the content file (block 680-NO), process 600 may also include preventing content delivery (block 690). For example, network provider server 230 may delete or discard the content file without providing the content file to user device 210. Alternatively, network provider server 230 may direct content provider server 220 to prevent delivery of the content file. As a result, an account of user device 210 may not be charged since the user device 210 did not receive the content file. In some implementations, network provider server 230 may prevent delivery of a portion of the content file while allowing delivery of another portion of the content file (e.g., when user device preferences or content provider preferences do not authorize delivery of the portion of the content file but authorizes delivery of the other portion of the content file).

If, on the other hand, the account of user device 210 is authorized to be charged for delivery of the content file (block 670-YES) or if the account of content provider server 220 is authorized to be charged for delivery of the content file (block 680-YES), process 600 may include providing the content to the user device (block 650) and providing delivery charge information to the billing server (block 660). For example, as described above, network provider server 230 may deliver the content file to user device 210 when user device delivery preferences field 420 indicates that the delivery of the content file is authorized to be charged to the account of user device 210 or when content provider preferences field 430 indicates that the delivery of the content file is authorized to be charged to the account of content provider server 220. Network provider server 230 may provide delivery charge information relating to the delivery of the content file to billing server 240. As a result, user device 210 may receive the content file and the account of user device 210 may be charged for delivery of the content file when a user of user device 210 or when an operator of content provider server 220 authorizes the account of user device 210 to be charged for the delivery of the content file.

In some implementations, the delivery charge information (e.g., information to identify responsible accounts to charge for the delivery of a content file) may be based on a tag included in the content file or may be based on some other information, such as the type of content file or an identifier of the content file. For example, assume that the content file does not include a tag. Given this assumption, network provider server 230 may determine responsible accounts (e.g., the account of content provider server 220, the account of user device 210, and/or some other account) to charge for the delivery of the content file based on information stored by content provider server 220 and/or network provider server 230 (e.g., information stored by delivery instructions field 440) that identifies responsible accounts by content file type and/or content file identifier. As a result, network provider server 230 may identify responsible accounts to charge for the delivery of the content file even when the content file does not include a tag.

While a particular series of blocks has been described above with regard to FIG. 6, the operations, data flows, and/or the order of the blocks may be modified in other implementations. Further, non-dependent operations and/or data flows may be performed in parallel. In some implementations, some blocks of process 600 may be repeated for multiple portions of a content file. For example, assume that a content file includes a first portion and a second portion. Given this assumption, network provider server 230 may provide the first portion and/or the second portion to user device 210 in accordance with information stored by delivery instructions field 440 and may provide, to billing server 240, delivery charge information corresponding to the delivery of the first portion and the second portion. For example, network provider server 230 may identify a first charge value corresponding to a value to charge to one or more accounts (e.g., an account of user device 210 and/or an account of content provider server 220) for delivery of the first portion, and may identify a second charge value corresponding to a value to charge one or more accounts for delivery of the second portion. Thus, different portions of a content file may be charged at different rates and may be charged to different parties.

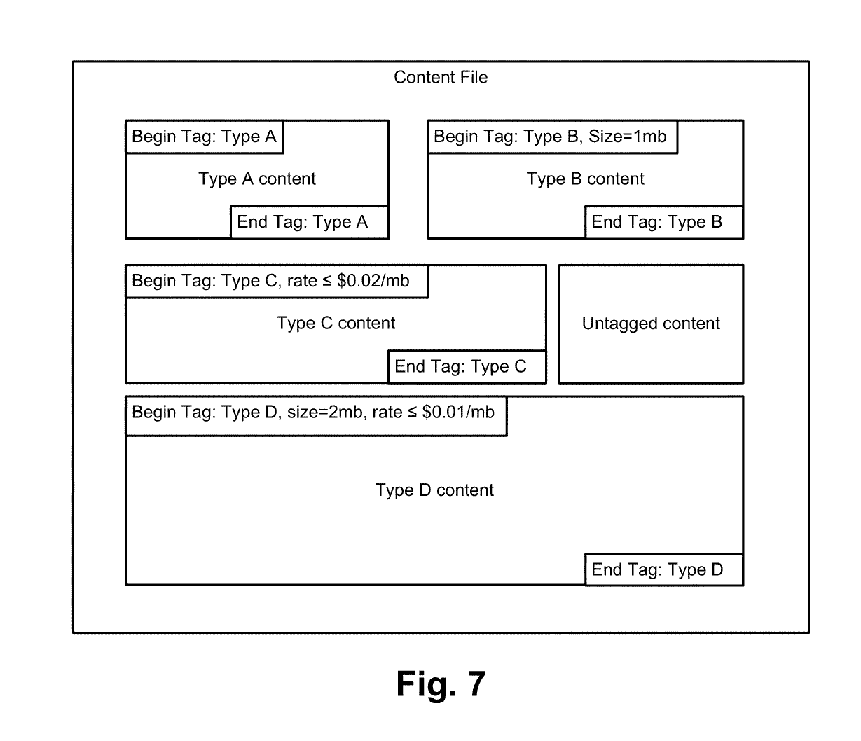

FIG. 7 illustrates an example implementation as described herein. As described above, content provider server 220 may tag a content file to identify portions of the content file that may be delivered to user device 210 at different billing rates. For example, as shown in FIG. 7, content provider server 220 may tag a content file to identify different types associated with different portions of the content file. For example, content provider server 220 may tag a first portion of the content file as “Type A” and may tag a second portion of the content file as “Type B.” Additionally, or alternatively, content provider server 220 may tag another portion of the content file as some other type (e.g., an advertisement type, an image type, etc.). As further shown in FIG. 7, a tag may identify a size of the portion of the content file and may identify a delivery rate of the content file. In some implementations, the tag may identify a responsible account to charge for delivery of the portion of the content file. In some implementations, and as shown in FIG. 7, content provider server 220 may omit tagging a particular portion of the content file.

FIG. 8 illustrates an example implementation as described herein. FIG. 8 illustrates an interface 800 of network provider server 230. As shown in FIG. 8, user device 210 may be used to provide, to network provider server 230 (e.g., via interface 800 or some other interface), information regarding delivery preferences for user device 210. As shown in FIG. 8, interface 800 may allow a particular user, associated with a user ID, to identify parameters and corresponding preferences relating to content files (or portions of content files) whose delivery may be charged to an account of user device 210. As shown in FIG. 8, the parameters may include content file type, content ID, content delivery charge rate, or identified by some other category of information (e.g., as described above with respect to delivery parameter field 420.1).

In some implementations, interface 800 may include preferences for content files, such as “Charge OK,” “No charge,” “Prompt,” or “Block.” As shown in FIG. 8, interface 800 may identify content files that the account of user device 210 may be charged for delivery (e.g., “Charge OK”), content files that the account of user device 210 may not be charged for delivery (e.g., “No charge”), content files that whose delivery may depend on a real-time response for authorization to charge the account of user device 210 for delivery (e.g., “Prompt), and/or content files that may not be delivered to user device 210 or charged to the account of user device 210 (“Block”). As an example, assume that the user of user device 210 selects to prevent the account of user device 210 from being charged for the delivery of advertisement type content files. Given this assumption, interface 800 may include an indicator (e.g., an “X” or some other indication) corresponding to “content type=advertisements” and “No charge.”

While a particular example is shown in FIG. 8, it will be apparent that the above description is merely an example implementation. Interface 800, shown in FIG. 8, is merely an example and in practice, the interface 800 may appear differently and may have a different format that what is shown in FIG. 8.

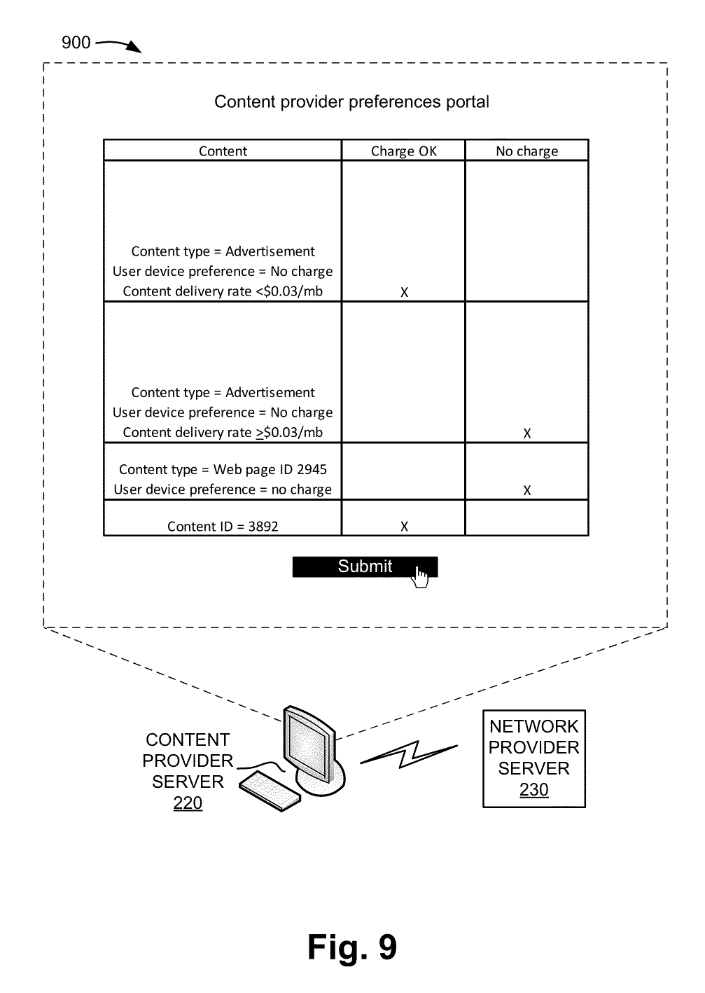

FIG. 9 illustrates an example implementation as described herein. FIG. 9 illustrates an interface 900 of network provider server 230. As shown in FIG. 9, content provider server 220 may be used to provide, to network provider server 230 (e.g., via interface 900 or some other interface), information regarding delivery preferences for content provider server 220. As shown in FIG. 9, interface 900 may allow an operator of content provider server 220 to identify parameters and corresponding preferences relating to content files (or portions of content files) whose delivery may be charged to an account of content provider server 220. As shown in FIG. 9, the parameters may include content file type, content ID, content delivery charge rate, or identified by some other category of information (e.g., as described above with respect to delivery parameter field 430.1). Similar to interface 800 shown in FIG. 9, interface 900 may include an indicator (e.g., an “X” or some other indication) identifying content files (or portions of content files) whose delivery may be charged to an account of content provider server 220.

While a particular example is shown in FIG. 9, it will be apparent that the above description is merely an example implementation. Interface 900, shown in FIG. 9, is merely an example and in practice, the interface 900 may appear differently and may have a different format that what is shown in FIG. 9.

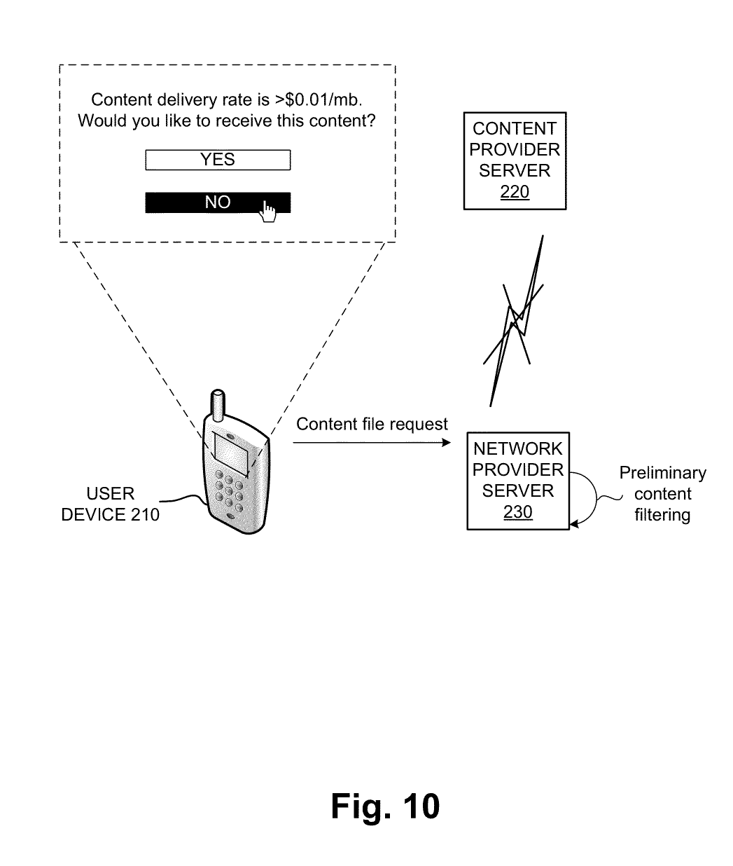

FIG. 10 illustrates an example implementation as described herein. In some implementations, FIG. 10 may illustrate a preliminary content filtering performed by network provider server 230. For example, network provider server 230 may perform the preliminary content filtering when receiving a content file request from user device 210. In some implementations, the preliminary content filtering may identify whether the content file may be delivered to user device 210 (e.g., based on user device preference information) and may prevent network provider server 230 from communicating with content provider server 220 when the content file may not be delivered to user device 210. As a result, network traffic, associated with the communication between network provider server 230 and content provider server 220, may be reduced when network provider server 230 determines that user device 210 should not receive the requested content file.

In FIG. 10, assume that user device preference information of user device 210 indicates that user device 210 is to be prompted for authorization to charge the account of user device 210 when user device 210 requests a content file whose delivery rate is >$0.01/mb. Further, assume that user device 210 provides network provider server 230 with a content file request and that the delivery rate of the requested content file is >$0.01/mb. In some implementations, network provider server 230 may prompt user device 210 for authorization to charge the account of user device 210 for delivery of the content file. In FIG. 10, assume that the user of user device 210 selects to prevent the content file from being delivered (i.e., the account of user device 210 may be not charged for the delivery of the content file). Given this assumption, network provider server 230 may not communicate with content provider server 220 to receive the content file from content provider server 220, thereby reducing network traffic.

In another example, assume that user device preference information of user device 210 indicates that user device 210 may not be charged for the delivery of a particular content file. Further, assume that content provider information of content provider server 220 indicates that the account of content provider server 220 may not be charged for the delivery of the particular content file. Further, assume that user device 210 requests the particular content file. Given these assumptions, network provider server 230 may perform the preliminary content filtering to determine that user device 210 may not receive the particular content file (e.g., since both the user device preference information and the content provider information prevent charging the accounts of user device 210 and content provider server 220) and may forgo communication with content provider server 220 regarding the particular content file, thereby reducing network traffic.

As described above, delivery charges and/or network usage charges for delivery of content may be split among multiple accounts (e.g., an account of user device 210, an account of content provider server 220 and/or some other account). Further, delivery instructions and/or delivery charge information may be determined based on user device preference information and/or based on content provider preference information. As a result, a content file may be delivered to user device 210 when a user of user device 210 authorizes a charge for the delivery of the content file or when an operator of content provider server 220 authorizes the charge for the delivery of the content file. Thus, the account of user device 210 may not be charged unless authorized while still being able to receive a content file from content provider server 220 when the account of content provider server 220 is authorized to be charged for delivery of the content file.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method comprising:
determining, by one or more servers, delivery charge information for delivery of a content file to a user device;
receiving, by the one or more servers, a first set of preferences associated with the user device,
the first set of preferences identifying whether the delivery of the content file can be charged to an account of a user associated with the user device;
receiving, by the one or more servers, a second set of preferences associated with the one or more servers,
the second set of preferences identifying whether the delivery of the content file can be charged to an account of a content provider associated with the one or more servers;
generating, by the one or more servers, a delivery instruction based on the first set of preferences, the second set of preferences, and the delivery charge information,
the delivery instruction identifying a first charge value to assess to the account of the user for the delivery of the content file,
the delivery instruction further identifying a second charge value to assess to the account of the content provider for the delivery of the content file;
receiving, by the one or more servers, a request for the content file from the user device,
the content file being delivered to the user device based on the request; and
causing, by the one or more servers, a billing settlement function to be performed to assess the first charge value to the account of the user or to assess the second charge value to the account of the content provider based on delivering the content file to the user device.

2. The method of claim 1, further comprising:
determining a network resource demand associated with the delivery of the content file,
where the delivery charge information is based on the network resource demand.

3. The method of claim 1, where the delivery instruction identifies whether to deliver the content file to the user device, the method further comprising:
preventing delivery of the content file when the delivery instruction identifies that the content file is not to be delivered to the user device,
where delivering the content file is based on the delivery instruction identifying that the content file is to be delivered to the user device.

4. The method of claim 1, further comprising:
determining that the account of the user is authorized to be charged for delivery of the content file,
where delivering the content file to the user device is based on determining that the account of the user is authorized to be charged for delivery of the content file.

5. The method of claim 1, further comprising:
determining that the account of the content provider is authorized to be charged for delivery of the content file,
where delivering the content file to the user device is based on determining that the account of the content provider is authorized to be charged for delivery of the content file.

6. The method claim 1, further comprising:
attaching a tag to the content file,
the tag identifying the first charge value or the second charge value,
the delivery instruction being based on the tag,
the billing settlement function being performed based information associated with the tag.

7. The method of claim 1, further comprising:
prompting the user device for delivery of the content file based on receiving the request for the content file from the user device;
receiving, from the user device, a response to the prompt,
the response identifying whether the one or more servers are to deliver the content file; and
preventing delivery of the content file when the response identifies that the one or more servers are not to deliver the content file,
where delivering the content file to the user device is based on the response identifying that the one or more servers are to deliver the content file.

8. The method of claim 1, where the content file includes a first portion and a second portion, the first charge value and the second charge value corresponding to the delivery of the first portion, the method further comprising:
determining a third charge value, associated with the account of the user, corresponding to the delivery of the second portion; and
determining a fourth charge value, associated with the account of the content provider, corresponding to the delivery of the second portion,
where causing the billing settlement function to be performed further includes assessing the third charge value to the account of the user device or assessing the fourth charge value to the account of one or more servers based on delivering the second portion.

9. A system comprising:
one or more servers to:
determine delivery charge information for delivery of a content file to a user device based on a network resource demand associated with the delivery of the content file;
receive a first set of preferences associated with the user device,
the first set of preferences identifying whether the delivery of the content file can be charged to an account of a user associated with the user device;
receive a second set of preferences associated with the one or more servers,
the second set of preferences identifying whether the delivery of the content file can be charged to an account of a content provider associated with the one or more servers;
generate a delivery instruction based on the first set of preferences, the second set of preferences, and the delivery charge information,
the delivery instruction identifying a first charge value to assess to the account of the user for the delivery of the content file,
the delivery instruction further identifying a second charge value to assess to the account of the content provider for the delivery of the content file;
receive a request for the content file from the user device,
the content file being delivered to the user device based on the request; and
cause a billing settlement function to be performed to assess the first charge value to the account of the user or to assess the second charge value to the account of the content provider based on delivering the content file to the user device.

10. The system of claim 9, where the delivery instruction identifies whether to deliver the content file to the user device, the one or more servers are further to:
prevent delivery of the content file when the delivery instruction identifies that the content file is not to be delivered to the user device,
where when delivering the content file, the one or more servers are further to deliver the content file when the delivery instruction identifies that the content file is to be delivered to the user device.

11. The system of claim 9, where the one or more servers include a first server, the first server is to:
receive, from the user device, the request for the content file;
provide, to a second server, the request for the content file;
receive, from the second server, the content file based on providing the request for the content file; and
deliver, to the user device, the content file received from the second server.

12. The system of claim 11, where the delivery instruction identifies whether the first server is to deliver the content file, the first server is further to:
prevent delivery of the content file when the delivery instruction identifies that the first server is not to deliver the content file; or
prevent communication between the first server and the second server when the delivery instruction identifies that the first server is not to deliver the content file;
where when providing the request for the content file to the second server, the first server is further to provide the request for the content file when the delivery instruction identifies that the first server is to deliver the content file.

13. The system of claim 9, where the one or more servers are further to:
attach a tag to the content file,
the tag identifying the first charge value or the second charge value,
delivery instruction being based on the tag,
the billing settlement function being performed based information associated with the tag.

14. The system of claim 9, where, the one or more servers are further to:
prompt the user device for delivery of the content file based on receiving the request for the content file from the user device;
receive, from the user device, a response to the prompt,
the response identifying whether the one or more servers are to deliver the content file; and
prevent delivery of the content file when the response identifies that the one or more servers are not to deliver the content file,
where when delivering the content file to the user device, the one or more servers are further to deliver the content file to the user device when the response identifies that the one or more servers are to deliver the content file.

15. The system of claim 9, where the content file includes a first portion and a second portion, the first charge value and the second charge value corresponding to the delivery of the first portion, the one or more servers are further to:
determine a third charge value, associated with the account of the user, corresponding to the delivery of the second portion; and
determine a fourth charge value, associated with the account of the content provider, corresponding to the delivery of the second portion,
where when causing the billing settlement function to be performed, the one or more servers are further to assess the third charge value to the account of the user device or assess the fourth charge value to the account of one or more servers based on delivering the second portion.

16. A computer-readable medium for storing instructions, the instructions comprising:
a plurality of instructions which, when executed by one or more processors associated with one or more servers, cause the one or more processors to:
determine delivery charge information for delivery of a content file to a user device,
the content file including a first portion and a second portion;
receive a first set of preferences associated with the user device,
the first set of preferences identifying whether the delivery of the first portion or the second portion of the content file can be charged to an account of a user associated with the user device;
receive a second set of preferences associated with the one or more servers,
the second set of preferences identifying whether the delivery of the first portion or the second portion content file can be charged to an account of a content provider associated with the one or more servers;
generate a delivery instruction based on the first set of preferences, the second set of preferences, and the delivery charge information,
the delivery instruction identifying a first charge value to assess to the account of the user for the delivery of the first portion of the content file,
the delivery instruction further identifying a second charge value to assess to the account of the content provider for the delivery of the first portion content file,
the delivery instruction further identifying a third charge value to assess to the account of the user for the delivery of the second portion of the content file,
the delivery instruction further identifying a fourth charge value to assess to the account of the content provider for the delivery of the second portion of the content file;
receive a request for the content file from the user device,
the content file being delivered to the user device based on the request; and
cause perform a billing settlement function to be performed to assess the first charge value to the account of the user, assess the second charge value to the account of the content provider, assess the third charge value to the account of the user, or assess the fourth charge value to the account of the content provider based on delivering the content file.

17. The computer-readable medium of claim 16, where the plurality of instructions further cause the one or more processors to:
determine a network resource demand associated with the delivery of the content file;
where one or more instructions, of the plurality of instructions, to determine the delivery charge value, further cause the one or more processors to determine the delivery charge value based on the network resource demand.

18. The computer-readable medium of claim 16, where the delivery instruction identifies whether to deliver the content file to the user device, the plurality of instructions further cause the one or more processors to:
prevent delivery of the content file when the delivery instruction identifies that the content file is not to be delivered to the user device,
where one or more instructions, of the plurality of instructions, to deliver the content file, further cause the one or more processors to deliver the content file when the delivery instruction identifies that the content file is to be delivered to the user device.

19. The computer-readable medium of claim 16, where the plurality of instructions further cause the one or more processors to:
attach a tag to the content file,
the tag identifying the first charge value or the second charge value,
delivery instruction being based on the tag,
the billing settlement function being performed based information associated with the tag.

20. The computer-readable medium of claim 16, where plurality of instructions further cause the one or more processors to:
prompt the user device for delivery of the content file based on receiving the request for the content file from the user device;
receive, from the user device, a response to the prompt,
the response identifying whether the one or more servers are to deliver the content file; and
prevent delivery of the content file when the response identifies that the one or more servers are not to deliver the content file,
where one or more instructions, of the plurality of instructions, to deliver the content file, further cause the one or more processors to deliver the content file to the user device when the response identifies that the one or more servers are to deliver the content file.
